(19) United States
(12) Patent Application Publication
(10) Pub. No.: US 2002/0119357 A1
(43) Pub. Date: Aug. 29, 2002

(54) High-temperature polymer electrolyte membrane (HTM) fuel cell, HTM fuel cell installation, method for operating an HTM fuel cell and/or an HTM fuel cell installation

(76) Inventors: Manfred Baldauf, Erlangen (DE); Rolf Brueck, Bergisch-Gladbach (DE); Armin Datz, Poxdorf (DE); Joachim Grosse, Erlangen (DE); Jorg-Roman Konieczny, Siegburg (DE); Manfred Poppinger, Uttenreuth (DE); Meike Reizig, Erpel (DE); Rittmar Von Helmolt, Mainz (DE)

Correspondence Address: LERNER AND GREENBERG, P.A., 2445 Hollywood Boulevard, Hollywood, FL, 33020, US

(21) Appl. No.: 10/046,097

(22) Filed: Jan. 7, 2002

Related U.S. Application Data
(63) Continuation of application No. PCT/DE00/02161, filed on Jul. 3, 2000.

(30) Foreign Application Priority Data
Jul. 5, 1999 (DE) 199 30 875.6
Dec. 23, 1999 (DE) 199 62 679.0

(51) Int. Cl. H01M 8/10; H01M 4/86; H01M 8/04

(52) U.S. Cl. 429/30; 429/44; 429/26; 429/24; 429/32; 429/13

(57) ABSTRACT

High-temperature polymer electrolyte membrane (HTM) fuel cells, installations including HTM fuel cells, methods for operating an HTM fuel cell, and an HTM fuel cell installation apply the principle of the known PEM fuel cell and overcomes the major drawback of this fuel cell. By selecting a new electrolyte and changing the operating conditions, in particular the temperature and the pressure, the fuel cells do not depend on water content.

### CROSS-REFERENCE TO RELATED APPLICATION

This application is a continuation of copending International Application PCT/DE00/02161, filed Jul. 3, 2000, which designated the United States.

BACKGROUND OF THE INVENTION

### Field of the Invention

The invention relates to a high-temperature polymer electrolyte membrane (HTM) fuel cell, to an installation including HTM fuel cells, and to a method for operating an HTM fuel cell and/or an HTM fuel cell installation.

The polymer electrolyte membrane (PEM) fuel cell, which as its membrane electrolyte has a base polymer to which [−SO₃H] groups are attached, is known from the book “Brennstoffzellen” [Fuel Cells] by K. Ledjeff (c.f. Mäller Verlag 1995). In this fuel cell, the electrolytic conduction takes place via hydrated protons. Accordingly, this membrane needs liquid water, i.e. under standard pressure needs operating temperatures that are lower than 100° C., in order to ensure the proton conductivity.

One of the drawbacks of the PEM fuel cell is that it is sensitive to CO-containing process gas and that it is dependent on the quantity of water that is present in the cell, which means, inter alia, that the process gases have to be externally humidified, so that the membrane does not dry.

International PCT publication No. WO 96/13872 A1 has disclosed a membrane, the proton conductivity of which is not restricted to temperatures that lie below the boiling point of water. European Patent Application No. EP 0 787 368 B1 has disclosed a membrane, to the surface of which finely distributed, catalytically active metal particles are applied.

### SUMMARY OF THE INVENTION

It is accordingly an object of the invention to provide a high-temperature polymer electrolyte membrane (HTM) fuel cell, HTM fuel cell installation, and method for operating an HTM fuel cell and/or an HTM fuel cell installation that overcome the hereinafore-mentioned disadvantages of the heretofore-known devices of this general type and that provides a fuel cell and/or a fuel cell installation which in terms of its design is similar to the PEM fuel cell, but overcome its major drawbacks, such as its dependence on the water content in the cell. A further object of the present invention is to provide a method for operating such a fuel cell and/or such a fuel cell installation.

With the foregoing and other objects in view, there is provided, in accordance with the invention, a high-temperature polymer electrolyte membrane (HTM) fuel cell operating substantially independently of the water content in the cell.

With the objects of the invention in view, there is also provided an HTM fuel cell installation. The HTM fuel cell unit has structural components and is operable in an operating pressure up to 0.3 bar vacuum and/or a temperature higher than the boiling point of water and lower than the decomposition lo and/or the melting temperature of the structural components.

With the objects of the invention in view, there is also provided a method for operating an HTM fuel cell. The method includes pressuring an HTM fuel cell stack between 0.3 and 5 bar absolute and/or maintaining a temperature of the HTM fuel cell stack between 80° C. to 300° C. Likewise, an HTM fuel cell installation is operated under the same conditions.

With the objects of the invention in view, there is also provided an HTM fuel cell installation. The installation includes an HTM fuel cell unit having a maximum temperature difference of no more than 30 K and/or a maximum pressure drop of no more than 150 mbar.

With the objects of the invention in view, there is also provided an HTM fuel cell installation including an HTM fuel cell unit tolerating up to 10,000 ppm of carbon monoxide in a process gas.

With the objects of the invention in view, there is also provided an HTM fuel cell installation including an HTM fuel cell unit using air as an oxidant and regulating a temperature of said HTM fuel cell unit with reaction air.

With the objects of the invention in view, there is also provided a method for operating an HTM fuel cell installation has the step of including up to 10,000 ppm of carbon monoxide in a process gas.

The subject matter of the present invention is a high-temperature polymer electrolyte membrane (HTM) fuel cell that operates substantially independently of the water content in the cell.

A further subject of the present invention is an HTM fuel cell that has a maximum temperature difference and/or a maximum pressure drop within the fuel cell unit and/or within the fuel cell stack of less than or equal to 30 K or less than 150 mbar, respectively. This means that there are no pressure and/or temperature differences greater than 30 K/150 mbar within the stack.

A further object of the invention is to provide an HTM fuel cell that tolerates up to 10,000 ppm of carbon monoxide in the process gas.

A further subject of the invention is a method for operating an HTM fuel cell and/or an HTM fuel cell installation, which is run at an operating pressure of the HTM fuel cell stack, which lies in the range from 0.3 to 5 bar absolute and/or an operating temperature which lies in the range from 80° C. to 300° C. A method for operating an HTM fuel cell and/or an HTM fuel cell installation in which up to 10,000 ppm of carbon monoxide are contained in the process gas is a further subject of the invention, as is a method for operating an HTM fuel cell and/or an HTM fuel cell installation in which the maximum temperature difference and/or pressure difference in the stack is less than or equal to 30 K or 150 mbar, respectively.

A final object the invention is to provide an HTM fuel cell installation having at least one HTM fuel cell unit that can be operated at an operating pressure of from 0.3 to 5 bar absolute and/or at an operating temperature of from 80° C. to 300° C.

Although the invention is described herein as embodied in a high-temperature polymer electrolyte membrane (HTM) fuel cell, HTM fuel cell installation, a method for operating an HTM fuel cell and/or an HTM fuel cell installation, it is nevertheless not intended to be limited to the details given, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments.

### DESCRIPTION OF THE PREFERRED EMBODIMENTS

Referring now to the embodiments of the invention in detail, it is noted that an operating pressure in the HTM fuel cell stack is 0.3 to 5 bar, preferably 0.5 to 3.5 bar absolute, particularly preferably 0.8 bar to 2 bar absolute.

An HTM (high-temperature polymer electrolyte membrane) fuel cell, also known as an HTM fuel cell unit, includes a membrane and/or matrix. The membrane and/or matrix contains a chemically and/or physically bound, self-dissociating, and/or autoproteolytic electrolyte. Two electrodes are situated on opposite sides of the membrane and/or matrix. Adjacent at least one electrode, a reaction chamber which closed off from the environment by in each case one terminal plate and/or a corresponding edge structure, devices which can be used to introduce and discharge the process gas into and from the reaction chamber being provided. The structural components of the HTM fuel cell are such that they withstand reduced pressure down to approximately 0.3 bar and temperatures up to 300° C. for a prolonged period.

According to one embodiment, the entry pressure P_{Air} in the air-operated fuel cell is less than or equal to 1.5 barₐ, depending on the characteristic curve f₍ₚ₎.

The system is operated at a voltage of from 150 V to 500 V, depending on the use of the stack.

The operating temperature in the HTM fuel cell stack, under the operating conditions prevailing in the stack, such as for example the prevailing operating pressure, is higher than the boiling point of water and lower than the decomposition and/or melting temperature of the structural components of the fuel cell, and is, for example, between 80° C. and 300° C., preferably between 100° C. and 230° C.

The term “substantially independently of the water content” is in this context understood as meaning that the cell does not have to be wetted or dried during the normal operating state. However, it also means that during starting or during operation situations in which water (e.g. in liquid state, on account of the risk of the gas diffusion pores of the electrode and/or of an axial passage becoming blocked and of the electrolyte being flushed out) can lead to performance being impaired, may arise. Rather, it means that the HTM fuel cell operates substantially independently of the water content, since it has a self-dissociating electrolyte, and/or a structural device in which water is collected and removed, and/or flushed-out electrolyte is temporarily stored.

There are a range of situations in which a drop in the temperature in the cell and therefore an accumulation of liquid product water in the cell are conceivable, e.g. when the power is restricted, with a lag in the cooling, or during cold-starting of the installation itself.

In such situations, a device or a method for discharging the liquid water from the gas-guiding layer and/or from the process gas channels is advantageous, since otherwise the water droplets would impede the flow of gas and/or the diffusion of gas in the cell and/or in the stack. By way of example, the device used is a water storage device integrated in the cell or a desiccant (sponge, silica gel, calcium chloride, etc.), in which the water is held until the operating temperature is reached and the water is discharged from the cell in vapor form together with the off-gases. A desiccant that undergoes an alkaline reaction with water (for example calcium chloride) is preferred, since it inhibits corrosion caused by acids which are present in the system and which it neutralizes. As a device, it is also possible to provide an increase in the cross section of the axial disposal ducts, so that the water can be discharged through the disposal duct even in the liquid state. In the case of the method, by way of example, the flow throughput of a process gas is increased in such a way that the condensed product water is blown out of the cell. If the stack is disposed in a pressure housing and/or if the stack is of open construction, the cells can be oriented in such a way that the water simply drops downward.

According to an advantageous configuration, a desiccant, such as for example silica gel, blue indicator gel, calcium chloride or some other hygroscopic substance, is integrated in the HTM fuel cell, and/or a drying device, in which atmospheric humidity can be reversibly absorbed during and after the HTM fuel cell installation has been shut down, is integrated. It is also possible to provide a drying device and/or a desiccant for a stack or a part of a stack.

An electrode includes an active catalyst layer, which contains a metallic catalyst, such as platinum or an alloy containing metals from the platinum group. According to one embodiment, to improve the porosity and/or the gas permeability, it may also include certain solid supports, such as for example carbon fabric, and/or filler, such as soot particles. According to one embodiment, the solid support for improving the porosity of the electrode is made from silicon carbide.

According to a further embodiment, the electrode does not have a solid support, but rather the active catalyst layer directly adjoins the membrane and/or is incorporated in the outer layer of the membrane. For this purpose, the electrode is applied directly to the membrane, by being rolled on, by spraying, by printing with ink, etc., without a support, such as a carbon paper, being used. Depending on the catalyst paste, it may be advantageous if the paste contains soot, so that gas-guiding structures are impressed into the electrocatalyst by the structure of the bipolar plate. A further configuration of this embodiment is possible through the use of a membrane, to the surface of which finely distributed, catalytically active metal particles (metal nonwoven) are applied.

According to one configuration, the membrane is of multilayer structure, so that the electrolyte, such as for example phosphoric acid, can be held more successfully in the membrane, between the layers. By way of example, a barrier layer is incorporated in the edge region of the membrane.

According to one advantageous embodiment of the HTM fuel cell, the electrolyte is a Bronsted acid, for example phosphoric acid and/or some other self-dissociating compound.

According to an advantageous configuration of the HTM fuel cell, the process gases in the HTM fuel cell unit and the product water are in gas form.

According to an advantageous embodiment of the HTM fuel cell, the devices which can be used to introduce and discharge process gas into and from the reaction chamber are configured in such a way that the process gas in adjacent reaction chambers can flow in countercurrent or crosscurrent and/or can be introduced alternately from one side and from the other side into the reaction chamber. In this way, the temperature gradient within the fuel cell can be kept as low as possible, and any catalyst poisoning caused by carbon monoxide at the gas inlet of a cell can be compensated for by changing the gas inlet. It is also advantageous if the cooling medium flows in countercurrent and/or crosscurrent with respect to one or both process-gas flows.

According to an advantageous configuration, a cooling system is contained in an HTM fuel cell stack. This cooling system may be constructed either in single-stage form or in two-stage form, including a primary cooling circuit and a secondary cooling circuit. The heated cooling medium of the primary cooling circuit is cooled in the secondary cooling circuit. The cooling system may be constructed either as a single-cell cooling configuration or as a multicell cooling configuration.

According to an advantageous configuration of the HTM fuel cell installation, a device that is used to preheat at least one process gas, i.e. oxidant and/or fuel, before it enters the stack, is provided. It is preferable for the oxidant to be preheated. The process gas is preheated, for example, to a temperature of between 80° C. and 130° C., preferably between 100° C. and 110° C. The waste heat from a reformer and/or any other waste heat, such as for example the waste heat from the HTM fuel cell stack, can be used for preheating. In this connection, consideration may be given, for example, to partial recycling of the cathode outgoing air for preheating, which may take place in a lambda-controlled (for the direct methanol fuel cell) and/or temperature-controlled manner.

To avoid contaminating the cell or damaging it as a result of foreign bodies being admitted, the air is preferably filtered before it enters the cell. In this context, a distinction is drawn between process air (oxidant) and cooling air. A fine filter is preferred for the process air, since the cross section of the distribution channel for the process gases is preferably kept at a low level. It is preferable for a coarse filter to be combined with a fine filter, e.g. an electrostatic filter. Compared to other fine filters, this combination has the advantage of a lower pressure loss.

A coarse filter, which serves primarily to filter out particles that damage the cell and/or the cooler and/or block a passage, is used for the coolant.

According to an advantageous configuration of the HTM fuel cell installation, a power controller is dependent on the stack voltage is provided.

According to an advantageous configuration of the invention, the current and/or voltage can be tapped at a plurality of locations within the fuel cell stack. A separate resistance can be applied to each device for tapping current and/or voltage. By way of example, in a stack including 70 cells, a voltage tap is in each case provided after 12, 24, 42, 50 and 60 cells.

According to an advantageous configuration of the HTM fuel cell installation, a blower is present or the compressor of the installation is used in such a way that the HTM fuel cell unit(s) and/or the cooling system can be blown through and/or blown dry before the installation is started and/or after it has been shut down. The power supply to the module may be effected externally, by a separate energy storage device, such as for example an installation and/or a storage battery, and/or by the stack itself, or, finally, by a flywheel mass. To protect against environmental humidity and moisture from the system, it is particularly preferred, in this configuration, for the control mechanism or the flap through which the system is blown dry to be closed after the system has been blown dry, so that the stack is shut off from atmospheric humidity.

According to an advantageous configuration of the HTM fuel cell installation, there is at least one device for the preparation of process gas, in particular for the preparation of fuel, so that the anode gas that is introduced into the HTM fuel cell unit of the installation is cleaned. This device may, for example, be a hydrogen-permeable barrier membrane, which is used to remove CO from the anode gas of an HTM fuel cell installation with reformer, in particular at temperatures below 120° C.

According to an advantageous configuration of the HTM fuel cell installation, there is provision for the complete stack to be insulated, for the active cell part of the stack (the active cell part is the part of the stack from which current is taken off) to be insulated, for part of the stack and/or some other module and/or a line (such as for example a copper line) of the installation to be insulated, in order to prevent the stack from freezing and/or to maintain the operating temperature so as to improve the start-up performance. The insulated part may be separated by a membrane, a convection barrier, a thermal barrier, a flap, and/or a plurality of such elements. In the case of part of the stack being insulated, the remainder of the stack can be heated during starting, for example by the waste heat from this part.

The insulation may be low-temperature insulation primarily against convection and heat conduction, preferably an air gap or vacuum insulation. The use of a latent heat storage material (phase change material) is also preferred. The latent heat storage material used is particularly preferably paraffin, which undergoes a phase change at between 90 and 95° C. and has a very high heat capacity among latent heat storage materials. Moreover, it can be incorporated relatively easily in bound form in matrix materials or fabrics and is insensitive to water and acid. A further advantage is that when using paraffin there is no expansion of the material caused by the phase change.

The latent heat storage material may, for example, be accommodated in a double-walled housing of a stack. It is in this case advantageous if at least one feed opening for process and/or cooling medium can be closed, for example by electrically actuable flaps and/or thermostatic valves.

The insulation and/or other measure for cold-starting of the system is preferably constructed in such a way that the system, after it has been out of operation for up to 24 h, produces half of its maximum output after at most 1 min., preferably after at most 35 s. After the system has been out of operation for three weeks, a criterion for the cold-starting performance of the system is that half the maximum output be reached in less than 5 min., preferably less than 3 min.

According to an advantageous configuration of the HTM fuel cell installation and of the operating method, dynamic temperature control is provided. At least one measurer for measuring the temperature is provided in at least one stack of the fuel cell installation and/or in at least one fuel cell unit. A control device that is connected to this measurer controls the output released by the cooler and/or heater after it has compared the actual temperature value measured in the stack and/or in the fuel cell unit with a predetermined temperature value.

According to an advantageous configuration of the HTM fuel cell installation and of the operating method, a modular media preparer is provided, so that the individual assemblies or modules of the installation, such as for example HTM fuel cell stack, reformer, blower, and fan can in each case be run in their optimum action range. The individual assemblies of the installation accordingly may be in a plurality of modules, so that, for example when an HTM fuel cell stack is operating under partial load, a reformer module is operated at full load, so that each of the appliances is operating in its optimum action range.

In the installation with a reformer, a temporary hydrogen storage device, such as a palladium sponge, a pressure vessel, and/or a hydride storage device, may be provided.

According to one configuration of the installation, a gas-cleaning installation is provided, in which the exhaust gases are cleaned before they leave the installation.

According to one configuration of the installation, the stack is disposed in a pressure-carrying outer housing. In this case, at least one process gas is transported by the internal pressure prevailing in the housing so as to be converted at the active cell surfaces.

According to an advantageous configuration of the method, the process gas is preheated before it is introduced into the HTM fuel cell stack. The waste heat from the stack or another assembly of the HTM fuel cell system can, for example, be used for preheating. According to an advantageous configuration of the method, cooling medium that is heated during starting is introduced at least into the primary cooling circuit, so that during the starting operation the cooling circuit serves as a heater. By way of example, the cooling medium of the primary cooling circuit is supplied at a temperature of between 80° C. and 130° C., preferably between 100 and 110° C.

According to an advantageous configuration of the method, the process gases and/or the cooling medium are guided in countercurrent and/or in crosscurrent, so that the formation of a temperature gradient within the HTM fuel cell stack is suppressed. The maximum temperature difference within the fuel cell unit is less than or equal to 30 K.

According to an advantageous configuration of the method, when the cell is being shut down, the cell and/or the cooling system is blown through and/or blown dry using process gas and/or inert gas, so that during starting the cell is as far as possible free of water and the cooling system is as empty as possible. This therefore leads to an improvement in efficiency in particular because during starting, the cell is initially still at temperatures below 100° C., and liquid water that is present flushes out a physically bound electrolyte, and the cooling system can be heated significantly more quickly without cooling medium. Moreover, the cooling medium that is stored externally when the system is not operating, can be heated externally, for example electrically and/or using waste heat, during starting and/or before starting and can be admitted to the cooling system as heating medium or as a latent heat storage device. It is preferable for the externally stored cooling medium to be admitted to the stack in a temperature-controlled manner.

The HTM fuel cell is preferably operated at an ambient temperature of −30° C. to +45° C. The HTM fuel cell also can be operated in self-induction mode with air as oxidant. When air is used as oxidant (self-induction or using a compressor), it is possible to use reaction air for regulating the stack temperature, i.e. also for cooling.

According to an advantageous configuration of the invention, the HTM fuel cell installation has two cooling circuits, a primary high-temperature cooling circuit and a secondary low-temperature cooling circuit. The primary high-temperature cooling circuit is used to cool the stack and the heated cooling medium from the primary cooling circuit for its part being cooled in the secondary cooling circuit.

The cooling medium of the primary cooling circuit is a synthetic and/or natural oil in the broadest possible sense, which corresponds to the requirements, such as for example that the vapor pressure, under the pressure in the cooling system in the operating temperature range, be low and that the cooling medium be chemically inert. A high pressure in the cooling system reduces the vapor pressure and is therefore preferred for low-boiling cooling media. The oil used is preferably an electrically nonconductive medium that has a high boiling point. The connection between primary cooling circuit and secondary cooling circuit is preferably made via a heat exchanger. The cooling medium of the secondary cooling circuit may, for example, be water, and/or an alcohol.

The quantity of coolant in the high-temperature polymer fuel cell can be calculated, for example, as follows:

For gaseous cooling medium, for example cooling air:

V_{Coolingair}[m³/h]=(power[kW]·3600)/(cp_{Air}·Δ_{T}·ρ_{Air})

For liquid cooling medium, for example cooling water:

V_{Coolingwater}[l/h]=(power[kW]·3600·1000)/(cp_{Air}·Δ_{T}·ρ_{Water})

minus the enthalpy of vaporization of the water and minus the reaction air.

According to an advantageous configuration of the method, the HTM fuel cell installation and/or at least the HTM fuel cell stack(s) included in the installation, while the system is not operating, is held at a temperature which is higher than the freezing point of the electrolyte, so that starting can take place substantially, i.e. after the introduction of process gas and application of a voltage has taken place, autothermally.

According to an advantageous configuration of the method, the HTM fuel cell is dried by heating when it is not operating, so that, for example, in short periods of operation, when inoperative and/or loaded phases are short, the stack temperature in standby mode is kept substantially above the freezing point of the electrolyte. This can be achieved, for example, by setting a maintenance load during the inoperative phase.

The term fuel cell installation is used to denote the entire fuel cell system, which includes at least one stack with at least one fuel cell unit, the corresponding process-gas feed and discharge ducts, the end plates, the cooling system with cooling liquid and all the fuel cell stack peripherals (reformer, compressor, blower, heating for preheating the process gas, etc.).

A fuel cell unit includes at least one membrane and/or matrix with a chemically and/or physically bound electrolyte, two electrodes, which are situated on opposite sides of the membrane and/or matrix, adjacent to at least one electrode a reaction chamber, which is closed off from the environment by in each case a terminal plate and/or a corresponding edge structure, devices which can be used to introduce and discharge the process gas into and from the reaction chamber being provided.

The term stack refers to the stack including at least one fuel cell unit with the associated lines and at least part of the cooling system.

The term “withstands for a prolonged period” is intended to mean that the structural components are created for the operating conditions (pressure and temperature) described.

The term process gas denotes the gas/liquid mixture which is passed through the fuel cell units and which includes at least reaction gas (fuel/oxidant), inert gas and product water.

The term short-time operation is used, for example when the system is employed as a drive unit for a vehicle, to denote a shopping trip, during which the vehicle is regularly switched off for a few minutes and then has to be restarted.

The invention is based on the principle of the known PEM fuel cell, and overcomes the major drawbacks of this cell by selecting a new electrolyte and changing the operating conditions, in particular the temperature and the pressure. Like the conventional PEM fuel cell, the HTM fuel cell is suitable for both stationary and mobile fuel cell systems.

We claim:

1. A high-temperature polymer electrolyte membrane (HTM) fuel cell operating substantially independently of the water content in the cell.

2. The HTM fuel cell according to claim 1, comprising a desiccant.

3. The HTM fuel cell according to claim 1, including an electrode with a solid support made from silicon carbide.

4. The HTM fuel cell according to claim 3, wherein said electrode includes an active catalyst layer being applied directly to the membrane.

5. An HTM fuel cell installation, comprising an HTM fuel cell unit having structural components and being operable in at least one of an operating pressure up to 0.3 bar vacuum and a temperature higher than the boiling point of water and lower than at least one of the decomposition and the melting temperature of the structural components.

6. The HTM fuel cell installation according to claim 5, wherein said HTM fuel cell unit is operable at least at one of an operating pressure of 0.3 to 5 bar absolute and at an operating temperature of 80° C. to 300° C.

7. The HTM fuel cell installation according to claim 5, including a device with a process gas being preheated before entering the system.

8. The HTM fuel cell installation according to claim 5, including a device with a coolant being preheated before entering the system.

9. The HTM fuel cell installation according to claim 5, including a device for measuring the temperature.

10. The HTM fuel cell installation according to claim 5, including a device for controlling the temperature.

11. The HTM fuel cell installation according to claim 5, including a latent heat storage device for maintaining a predeterminable temperature in at least part of the stack while not operating.

12. The HTM fuel cell installation according to claim 5, including a thermal insulation for maintaining a predeterminable temperature in at least part of the stack while not operating.

13. The HTM fuel cell installation according to claim 5, including a local heater for maintaining a predeterminable temperature in at least part of the stack while not operating.

14. The HTM fuel cell installation according to claim 11, wherein said latent heat storage material is paraffin.

15. The HTM fuel cell installation according to claim 7, including a device for filtering the process gas before the process gas enters said HTM fuel cell unit.

16. The HTM fuel cell installation according to claim 8, including a device for filtering the coolant before the coolant enters said HTM fuel cell unit.

17. The HTM fuel cell installation according to claim 5, including a blower.

18. The HTM fuel cell installation according to claim 5, including a compressor.

19. The HTM fuel cell installation according to claim 7, including a device for preparing the process gas.

20. The HTM fuel cell installation according to claim 5, including:
a stack with an insulated part and an uninsulated part; and
a membrane separating said insulated part from said uninsulated part.

21. The HTM fuel cell installation according to claim 5, including:
a stack with an insulated part and an uninsulated part; and
a convection barrier separating said insulated part from said uninsulated part.

22. The HTM fuel cell installation according to claim 5, including:
a stack with an insulated part and an uninsulated part; and
a thermal barrier separating said insulated part and said uninsulated part.

23. The HTM fuel cell installation according to claim 5, including:
a stack with an insulated part and an uninsulated part; and
a flap separating said insulated part and said uninsulated part.

24. The HTM fuel cell installation according to claim 5, including:
a pressure-carrying external housing; and
a stack accommodated in said pressure-carrying external housing.

25. The HTM fuel cell installation according to claim 5, including a modular preparer for preparing media.

26. The HTM fuel cell installation according to claim 5, including a reformer for connecting to a temporary hydrogen storage device.

27. The HTM fuel cell installation according to claim 5, including a gas-cleaning installation.

28. The HTM fuel cell installation according to claim 5, including a closable feed opening.

29. The HTM fuel cell installation according to claim 28, including a process-gas feed line connected to said closable feed opening.

30. The HTM fuel cell installation according to claim 28, including a coolant feed line connected to said closable feed opening.

31. The HTM fuel cell installation according to claim 5, including a cooler for a single-cell.

32. The HTM fuel cell installation according to claim 5, including a cooler for multiple cells.

33. The HTM fuel cell installation according to claim 5, wherein said HTM fuel cell unit operates at a voltage between 150 V and 500 V.

34. The HTM fuel cell installation according to claim 5, including a device for discharging liquid water.

35. The HTM fuel cell installation according to claim 5, including:
a fuel cell stack; and
two devices for tapping current being disposed at said fuel cell stack.

36. A method for operating an HTM fuel cell, which comprises at least one of:
pressuring an HTM fuel cell stack between 0.3 and 5 bar absolute; and
maintaining a temperature of the HTM fuel cell stack between 80° C. to 300° C.

37. The method according to claim 36, which further comprises preheating a process gas before introducing the process gas into the HTM fuel cell stack.

38. The method according to claim 36, which further comprises:
releasing a cooling medium from a cooling system when the cooling system is not operating; and
admitting the cooling medium into the cooling system at least before starting the fuel cell stack.

39. The method according to claim 38, which further comprises admitting the cooling medium into the cooling system while starting the fuel cell stack.

40. The method according to claim 38, which further comprises preheating the cooling medium.

41. The method according to claim 38, which further comprises controlling a temperature of the cooling medium.

42. The method according to claim 37, which further comprises guiding the process gases in countercurrent.

48. The method according to claim 37, which further comprises guiding the process gases in crosscurrent.

49. The method according to claim 38, which further comprises guiding the cooling medium in countercurrent.

50. The method according to claim 38, which further comprises guiding the process gases in crosscurrent.

51. A method for operating an HTM fuel cell installation, which comprises:
providing a stack of HTM fuel cell units; and
at least one of pressuring an HTM fuel cell stack between 0.3 and 5 bar absolute and maintaining a temperature of the HTM fuel cell stack between 80° C. to 300° C.

52. The method according to claim 51, which further comprises blowing a fuel cell unit with a medium.

53. The method according to claim 52, wherein the blowing step is blowing through the fuel cell unit.

54. The method according to claim 52, wherein the blowing step is blowing dry the fuel cell unit.

55. The method according to claim 52, which further comprises closing the fuel cell unit after the blowing step.

56. The method according to claim 51, which further comprises blowing a cooling system connected to the fuel cell stack.

57. The method according to claim 56, wherein the blowing step is blowing through the cooling system.

58. The method according to claim 56, wherein the blowing step is blowing dry the cooling system.

59. The method according to claim 56, which further comprises closing the cooling stem after the blowing step.

60. The method according to claim 51, which further comprises:
cooling the stack with a primary cooling circuit; and
cooling the stack with a secondary cooling circuit.

61. The method according to claim 51, which further comprises:
using an electrolyte in the HTM fuel cells of the stack;
autothermally starting the stack by heating the HTM fuel cells to a higher temperature than the freezing point of the electrolyte when the system is not operating.

62. The method according to claim 36, which further comprises binding liquid water bound in the cell so that the water droplets do not impede the flow and diffusion of gas.

63. The method according to claim 36, which further comprises discharging from the cell liquid water bound in the cell so that the water droplets do not impede the flow of gas and diffusion of gas.

64. An HTM fuel cell installation, comprising an HTM fuel cell unit having at least one of a maximum temperature difference of no more than 30 K and a maximum pressure drop of no more than 150 mbar.

65. An HTM fuel cell installation, comprising an HTM fuel cell unit tolerating up to 10,000 ppm of carbon monoxide in a process gas.

66. An HTM fuel cell installation, comprising an HTM fuel cell unit using air as an oxidant and regulating a temperature of said HTM fuel cell unit with reaction air.

67. A method for operating an HTM fuel cell installation, which comprises including up to 10,000 ppm of carbon monoxide in a process gas.
